(19) United States
(12) Patent Application Publication
(10) Pub. No.: US 2012/0326400 A1
(43) Pub. Date: Dec. 27, 2012

(54) Chuck

(76) Inventor: Jack LIN, Taichung City (TW)

(21) Appl. No.: 13/194,620

(22) Filed: Jul. 29, 2011

Related U.S. Application Data
(63) Continuation-in-part of application No. 13/165,591, filed on Jun. 21, 2011.

(51) Int. Cl. B23B 31/107

(52) U.S. Cl. 279/75

(57) ABSTRACT

A chuck includes a cylinder, a ball, two spring-loaded pushers and a spring-loaded sleeve. The cylinder includes a hexagonal pocket axially defined therein, a circular pocket axially defined therein, and an aperture transversely defined therein. The ball is movably located in the aperture so that the ball can be inserted partially in the hexagonal pocket. The first pusher is movably located in the circular pocket for pushing a bit. The second pusher is movably located around the cylinder and abutted against the ball. The sleeve is movably located on the cylinder and formed with first and second annular ribs on an internal side thereof. The first rib is abutted against the second pusher while the second rib is abutted against the ball so that the ball is kept in the aperture while the second pusher is retained around the cylinder.

### CROSS-REFERENCE

The present invention is a continuation-in-part application of co-pending U.S. patent application Ser. No. 13/165,591 filed on 21 Jun. 2011.

### BACKGROUND OF INVENTION

1. Field of Invention

The present invention relates to a chuck and, more particularly, to a convenient and reliable chuck.

2. Related Prior Art

In addition to the conventional chucks addressed in co-pending U.S. patent application Ser. No. 13/165,591 filed on 21 Jun. 2011, conventional chucks can be found in U.S. Pat. Nos. 7,121,774, 6,457,916, 6,874,791 and 6,953,196. These conventional chucks involve complicated structures and/or provide dissatisfactory operation.

The present invention is therefore intended to obviate or at least alleviate the problems encountered in prior art.

### SUMMARY OF INVENTION

It is an objective of the present invention to provide a convenient chuck.

It is another objective of the present invention to provide a reliable chuck.

To achieve the foregoing objectives, the chuck includes a cylinder, a ball, two spring-loaded pushers, and a spring-loaded sleeve. The cylinder includes a hexagonal pocket axially defined therein, a circular pocket axially defined therein, and an aperture transversely defined therein. The ball is movably located in the aperture so that the ball can be inserted partially in the hexagonal pocket. The first pusher is movably located in the circular pocket for pushing a bit. The second pusher is movably located around the cylinder and abutted against the ball. The sleeve is movably located on the cylinder and formed with first and second annular ribs on an internal side thereof. The first rib is abutted against the second pusher while the second rib is abutted against the ball so that the ball is kept in the aperture while the second pusher is retained around the cylinder.

The chuck may further include a first spring for biasing the first pusher. The first pusher may include a tunnel defined therein for receiving a portion of the spring. The chuck may further include a magnet attached to the spring for attracting the bit.

The chuck may further including a second spring for biasing the second pusher. The chuck may further include a ring fit in the sleeve so that the second spring is compressed between the ring and the second pusher.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a chuck according to the first embodiment of the present invention;

FIG. 2 is a cut-away view of the chuck shown in FIG. 1;

FIG. 3 is a cross-sectional view of the chuck shown in FIG. 2;

FIG. 4 is a cross-sectional view of the chuck in another position than shown in FIG. 3;

FIG. 5 is a cross-sectional view of the chuck in another position than shown in FIG. 4;

FIG. 6 is a cross-sectional view of the chuck in another position than shown in FIG. 5;

FIG. 7 is a view of the chuck in engagement with another bit other than shown in FIGS. 3 through 6;

FIG. 8 is a cross-sectional view of a chuck according to the second embodiment of the present invention; and

FIG. 9 is a cross-sectional view of the chuck in another position than shown in FIG. 8.

### DETAILED DESCRIPTION OF EMBODIMENTS

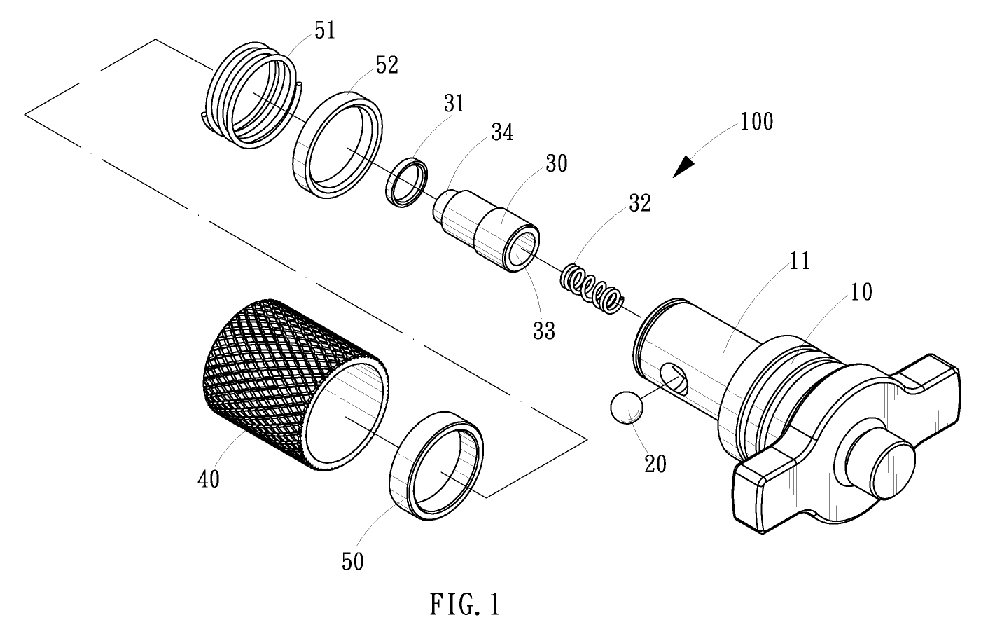

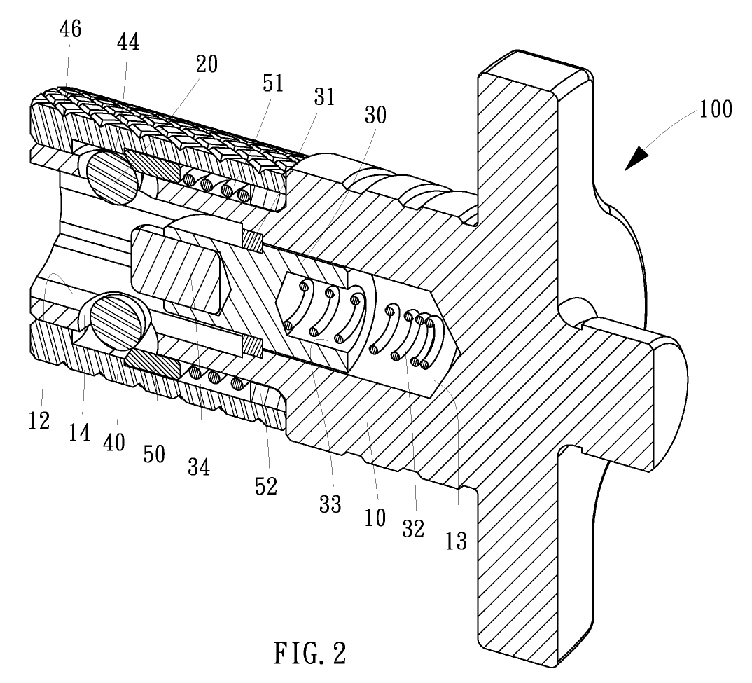

Referring to FIGS. 1 and 2, there is shown a chuck 100 according to a first embodiment of the present invention. The chuck 100 includes a cylinder 10, two balls 20, two pushers 30 and 50, a sleeve 40, a ring 52 and two springs 32 and 51. The cylinder 10 includes a hexagonal pocket 12 axially defined in an end 11 thereof, a circular pocket 13 axially defined therein, and two apertures 14 transversely defined in the end 11 thereof. The hexagonal pocket 12 is in communication with the circular pocket 13. The hexagonal pocket 12 is in communication with the apertures 14. The distance between any two opposite walls of the hexagonal pocket 12 is larger than or equal to the diameter of the circular pocket 13.

Each of the apertures 14 includes a small open end located near the hexagonal pocket 12 and an opposite large open end. The diameter of the balls 20 is smaller than the diameter of the large open ends of the apertures 14 but larger than the diameter of the small open ends of the apertures 14 so that each of the balls 20 is movable into a related one of the apertures 14 through the large open end but cannot be moved completely out of the same through the small open end. Each of the balls 20 can however be partially moved out of a related one of the apertures 14 through the small open end.

The pusher 30 is a tubular element with a tunnel 33 axially defined therein. A magnet 34 is fit in an open end of the tunnel 33. The pusher 30 includes an annular shoulder formed on an external side thereof so that the pusher 30 is divided into two sections on the external side thereof.

The sleeve 40 includes two annular ribs 44 and 46 formed on the internal side thereof. The annular ribs 44 and 46 are actually made one. The internal diameter of the annular rib 44 is larger than that of the annular rib 46. The internal diameter of the annular rib 46 is marginally larger than the external diameter of the end of eh cylinder 10.

In assembly, an end of the spring 32 is located in the tunnel 33 while another end of the spring 32 is located outside the tunnel 33. The spring 32 and the first section of the pusher 30 are located in the circular pocket 13. The second section of the pusher 30 is located in the hexagonal pocket 12. A ring 31 is located around the second section of the pusher 30, fit in the circular pocket 30, and abutted against the annular shoulder of the pusher 30 so that the pusher 30 is retained in the hexagonal pocket 12 and the circular pocket 13. The spring 32 is compressed between the magnet 34 and a closed end of the circular pocket 13.

The ring 52, the second spring 51 and the pusher 50 are sequentially located around the end 11 of the cylinder 10. Each of the balls 20 is located partially in a related one of the apertures 14. The pusher 50 is abutted against an external portion of each of the balls 20 as the second spring 51 is compressed between the second pusher 50 and the ring 52. The sleeve 40 is movably located on the end 11 of the cylinder 10 between a locking position and a releasing position. Now, the sleeve 40 is located around the ring 52, the second spring 51 and the pusher 50 so that the pusher 50 and the second spring 51 are movably located in the sleeve 40 while the ring 52 is fit in the sleeve 40, i.e., the ring 52 is not movable relative to the sleeve 40. The pusher 50 is abutted against the annular rib 44. Each of the balls 20 is retained partially in a related one of the apertures 14 by the annular rib 46 so that the ring 52, the second spring 51, the pusher 50 and the sleeve 40 are retained on the end 11 of the cylinder 10.

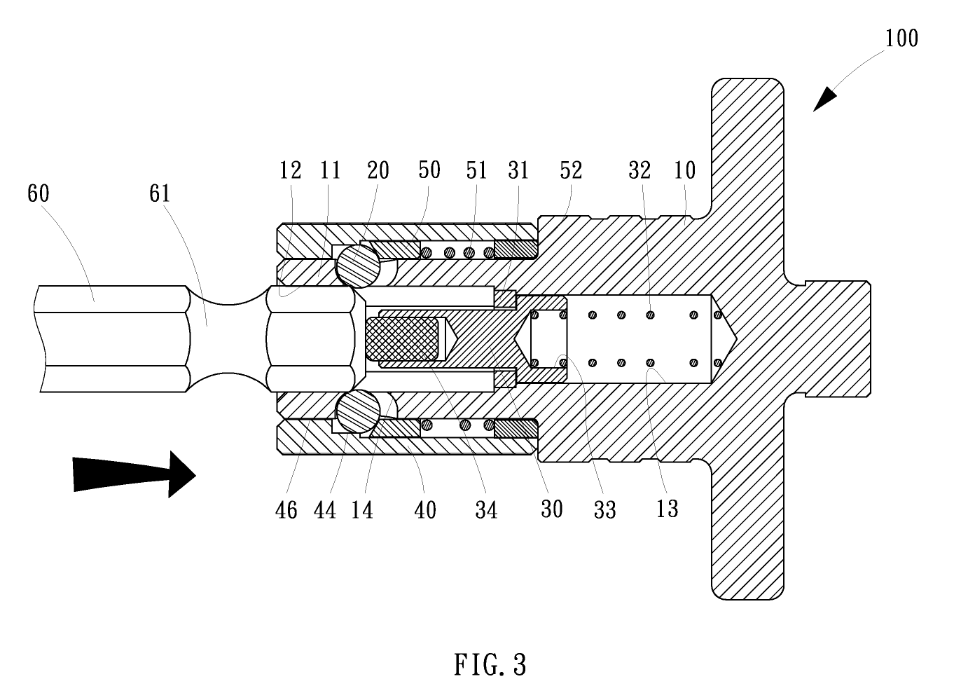

Referring to FIG. 3, there is shown a bit 60 in an early phase of insertion in the hexagonal pocket 12. An end of the bit 60 is just in contact with the balls 20. The bit 60 includes an annular groove 61 defined therein.

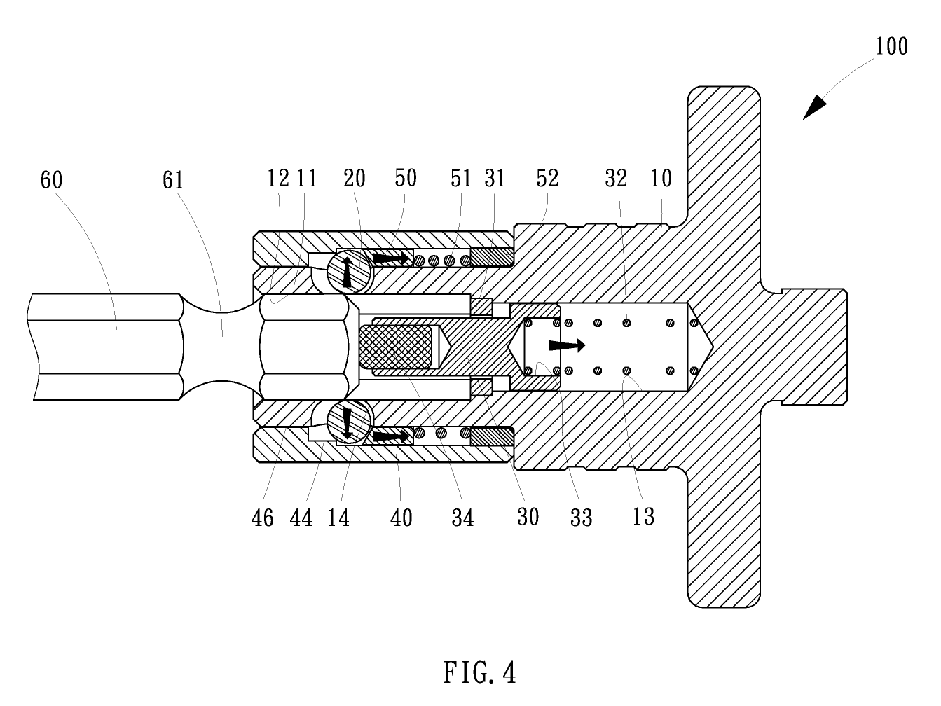

Referring to FIG. 4, the end of the bit 60 is inserted further into the hexagonal pocket 12. The balls 20 are moved out of the hexagonal pocket 12 against the second spring 51 while the first section of the pusher 30 is inserted further in to the circular pocket 13 against the first spring 32.

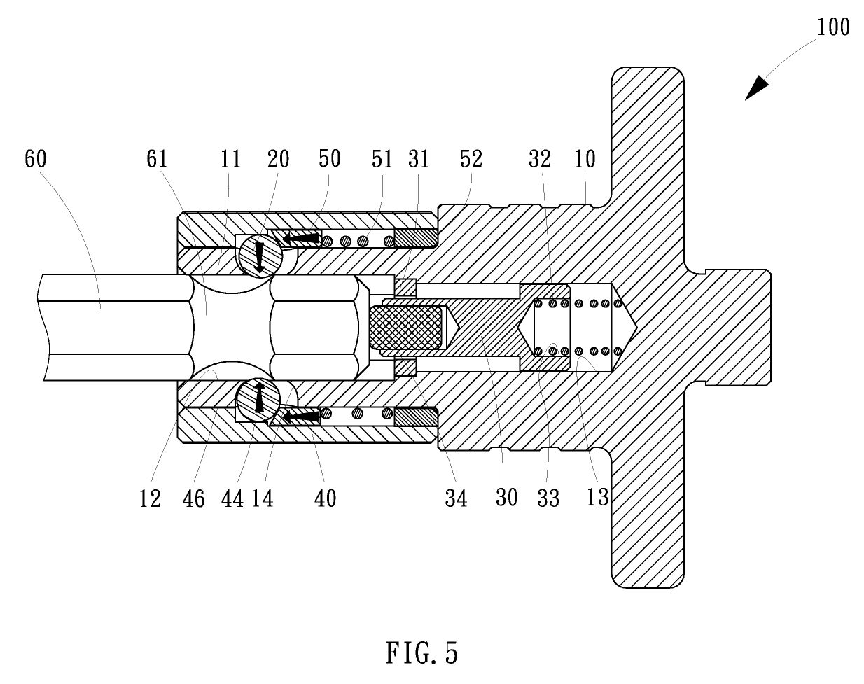

Referring to FIG. 5, the sleeve 40 is located in the locking position where the annular groove 61 is in communication with the apertures 14 so that each of the balls 20 is partially pushed into the annular groove 61 by the second spring 51 through the pusher 50. A portion of each of the balls 20 is abutted by the annular rib 44 so that another portion of the same is retained in the annular groove 61. Therefore, the bit 60 is locked to the chuck 100. Furthermore, each of the balls 74 partially enters an annular groove 61 defined in a bit 60, thus locking the bit 60 to the chuck 100.

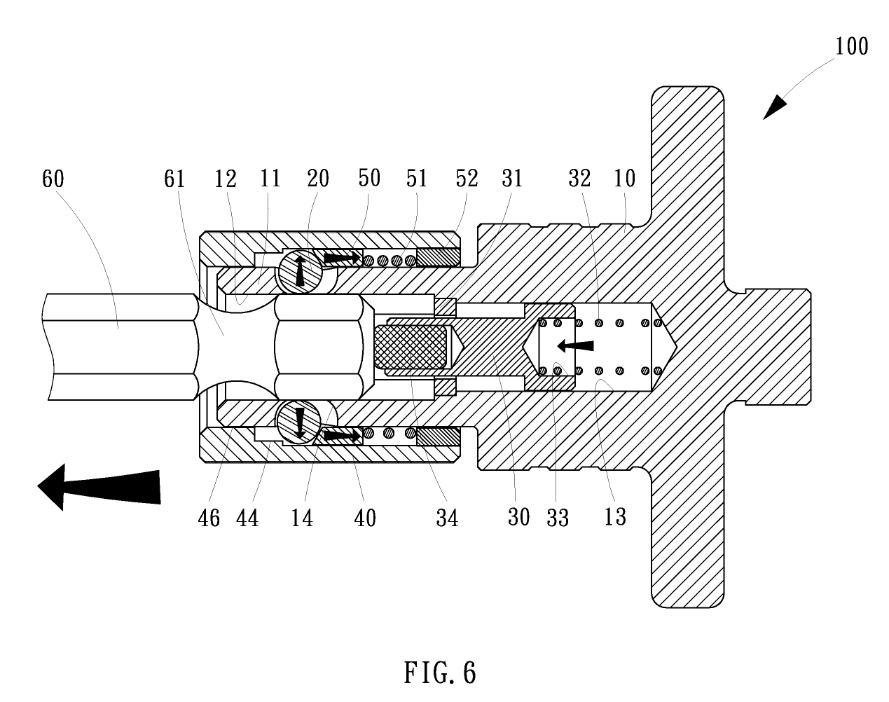

Referring to FIG. 6, the sleeve 40 is in the releasing position where the annular rib 44 is disengaged from the balls 20 so that the balls 20 can be moved out of the hexagonal pocket 12. The coefficient of elasticity of the first spring 32 is higher than that of the second spring 51 so that the first spring 32 pushes the bit 60 against the second spring 51. The bit 60 will not be ejected out of the hexagonal pocket 12 and get lost because it is attracted to the magnet 34.

The chuck 100 exhibits at least two advantages. At first, it is convenient since the first spring 32 automatically pushes the bit 60 against the second spring 51. Secondly, it is reliable since hexagonal pocket 12 because the magnet 34 attracts the bit 60 and hence prevents loss of the bit 60.

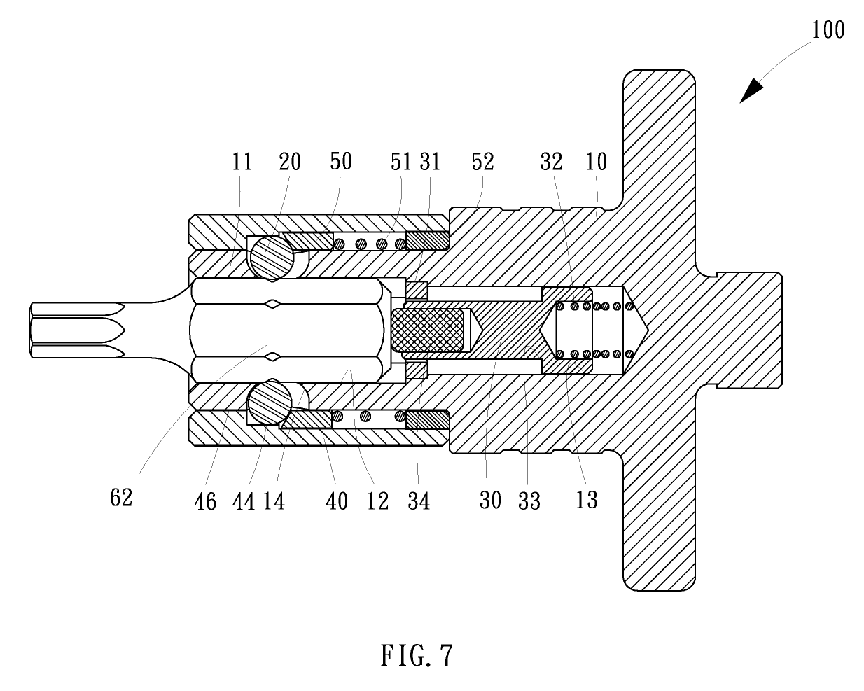

Referring to FIG. 7, another bit 62 is engaged with the chuck 100. The bit 62 includes six recesses instead of the annular groove 61. Each of the recess is defined in a corner of the bit 62.

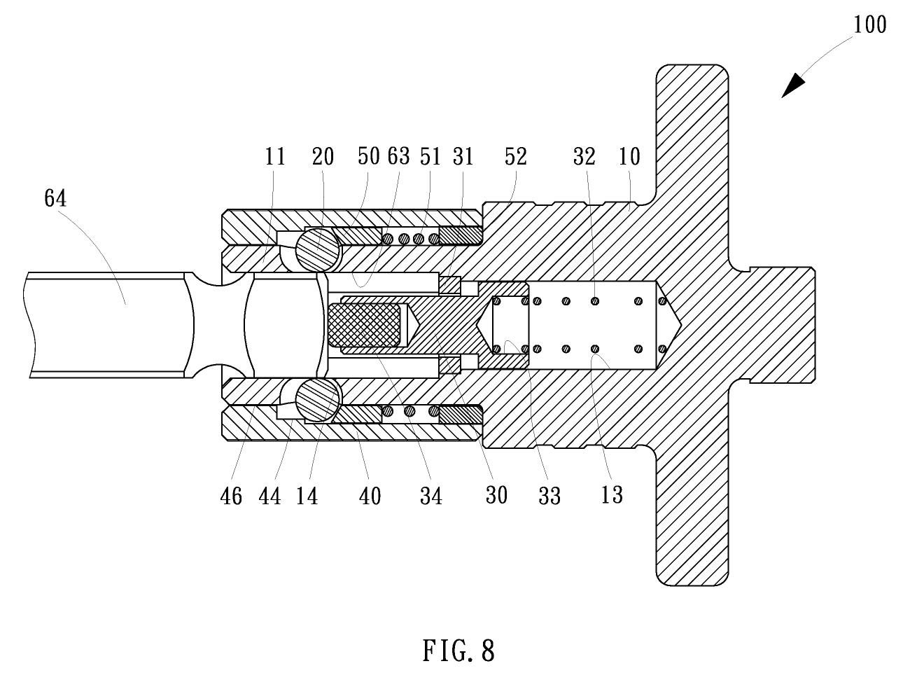

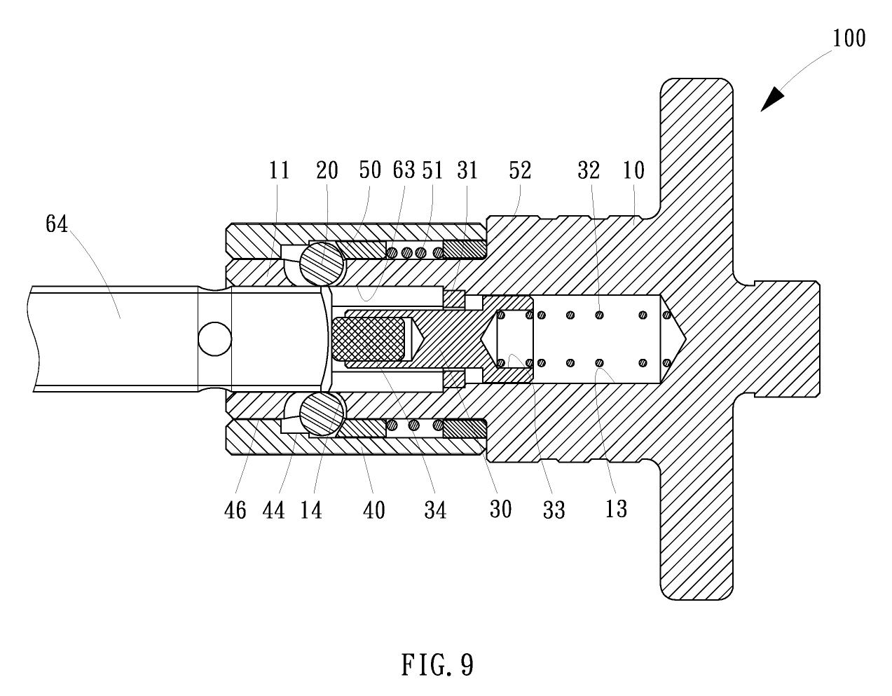

Referring to FIGS. 8 and 9, there is shown a chuck according to the second embodiment of the present invention. The second embodiment is like the first embodiment except that cylinder 10 includes a square pocket 63 instead of the hexagonal pocket 12. The square pocket 63 can receive a square bit 64.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A chuck including:
a cylinder including a hexagonal pocket axially defined therein, a circular pocket axially defined therein and in communication with the hexagonal pocket and an aperture transversely defined therein and in communication with the hexagonal pocket;
a ball movably located in the aperture so that the ball can be partially inserted in the hexagonal pocket;
a first pusher movably located in the circular pocket for pushing a bit;
a second pusher movably located around the cylinder and abutted against the ball; and
a sleeve movably located on the cylinder and formed with first and second annular ribs on an internal side thereof, wherein the first rib is abutted against the second pusher while the second rib is abutted against the ball so that the ball is kept in the aperture while the second pusher is retained around the cylinder.

2. The chuck according to claim 1, further including a spring for biasing the first pusher.

3. The chuck according to claim 2, wherein the first pusher includes a tunnel defined therein for receiving a portion of the spring.

4. The chuck according to claim 2, further including a magnet attached to the spring for attracting the bit.

5. The chuck according to claim 1, further including a spring for biasing the second pusher.

6. The chuck according to claim 5, including a ring fit in the sleeve so that the spring is compressed between the ring and the second pusher.

7. The chuck according to claim 1, wherein the first and second annular ribs are made one.
